(19) United States
(12) Patent Application Publication
(10) Pub. No.: US 2011/0267923 A1
(43) Pub. Date: Nov. 3, 2011

(54) APPARATUS AND METHOD FOR SEISMIC IMAGING USING WAVEFORM INVERSION SOLVED BY CONJUGATE GRADIENT LEAST SQUARES METHOD

(75) Inventor: Changsoo SHIN, Seoul (KR)

(73) Assignee: SNU R&DB FOUNDATION, Seoul (KR)

(21) Appl. No.: 12/890,278

(22) Filed: Sep. 24, 2010

(30) Foreign Application Priority Data
Apr. 30, 2010 (KR) 10-2010-0040984

(51) Int. Cl. G01V 1/50

(52) U.S. Cl. 367/49

(57) ABSTRACT

Provided is an apparatus for seismic imaging by using waveform inversion in the frequency domain. The seismic imaging apparatus includes: a waveform inversion unit obtaining an equation by applying a Gauss-Newton method to an objective function consisting of residuals of logarithmic wavefields in frequency-domain waveform inversion and then obtaining a parameter vector, which minimizes the objective function, by solving the equation using a conjugate gradient method; and a subsurface structure display unit generating subsurface structure information using the parameter vector obtained by the waveform inversion unit and displaying the generated subsurface structure information.

### CROSS-REFERENCE TO RELATED APPLICATION

This application claims the benefit under 35 U.S.C. §119(a) of a Korean Patent Application No. 10-2010-0040984, filed on Apr. 30, 2010, the entire disclosure of which is incorporated herein by reference for all purposes.

### BACKGROUND

1. Field

The following description relates to a seismic imaging apparatus, and more particularly, to an apparatus and method for seismic imaging by using waveform inversion in the frequency domain.

2. Description of the Related Art

Subsurface imaging technology is a basic and important tool for the exploration of oil and natural gas buried underground. Of subsurface imaging technologies, seismic imaging technologies involve the process of sending shock waves to a target medium, collecting response data from the surface of the target medium, and estimating the subsurface structure of the target medium based on the collected response data.

A discrete finite-element wave equation having appropriate boundary conditions is given by

Mü+C\dot{u}+Ku=f.

Coefficients of the wave equation are related to parameters indicating physical characteristics of a medium through which waves propagate. In seismic imaging, information about the structure of a medium is obtained through a study of waveform inversion in which the above parameters are estimated based on collected response data. The waveform inversion is performed in the time domain or the frequency domain and involves the process of obtaining parameters that minimize an objective function consisting of residuals between modeled data and measured data. In the frequency-domain waveform inversion, an example objective function may be defined by

E=e^{T}e*, (1)

where e=d−u, d is an observed wavefield vector, u is a modeled wavefield vector, and the subscript * denotes complex conjugate. To obtain a set of parameters that minimizes the objective function defined by Equation 1, a Gauss-Newton method is applied. The Gauss-Newton method is one of the algorithms used to solve a nonlinear least squares problem. Expanding the modeled wavefield u to first order term by Taylor's series gives:

E=[d−u₀−JΔp]^{T}[d−u₀−JΔp]*, (2)

where u₀ is a modeled wavefield vector using an initial velocity model, J is a Jacobian matrix indicating the sensitivity of wavefields to parameters, and Δp is a perturbation of a parameter vector. If Equation 2 is differentiated with respect to each element of the perturbation Δp based on least-squares principles and is then equated to zero, the following equation is obtained.

J^{T}J*Δp=J^{T}e₀*, (3)

where e₀=d−u₀.

Here, while Equation 3 includes the multiplication of very large matrices, a method of easily calculating the multiplication through modeling is available. Thus, the perturbation Δp can be obtained by solving Equation 3, and a parameter vector p can finally be calculated using the calculated perturbation Δp.

However, despite apparent merits in convergence speed, a simple method for solving logarithmic waveform inversion has not been known so far.

### SUMMARY

The following description relates to a method which applies a Gauss-Newton method to logarithmic waveform inversion.

In one general aspect, there is provided a seismic imaging apparatus including: a waveform inversion unit obtaining an equation by applying a Gauss-Newton method to an objective function consisting of residuals of logarithmic wavefields in the frequency-domain waveform inversion and then obtaining a parameter vector, which minimizes the objective function, by solving the equation using a conjugate gradient method; and a subsurface structure display unit generating subsurface structure information using the parameter vector obtained by the waveform inversion unit and displaying the generated subsurface structure information.

The waveform inversion unit may include: a coefficient matrix calculation unit calculating coefficient matrices of a linear matrix equation obtained by applying the Gauss-Newton method; and a conjugate gradient processing unit iteratively solving the linear matrix equation, which has the coefficient matrices calculated by the coefficient matrix calculation unit, by using the conjugate gradient method.

Other features and aspects will be apparent from the following detailed description, the drawings, and the claims.

### BRIEF DESCRIPTION OF THE DRAWINGS

FIG. 1 is a schematic block diagram of a seismic imaging apparatus according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The above and other aspects of the present invention will become more apparent by the following exemplary embodiments. The invention is described more fully hereinafter with reference to the accompanying drawings, in which exemplary embodiments of the invention are shown. The present invention can be implemented by, but is not limited to, a computer program. Thus, a method embodiment can be easily implemented based on an apparatus embodiment. Accordingly, the following description will focus on an apparatus invention.

U.S. patent Ser. No. 11/942,352 filed on Nov. 19, 2007 discloses waveform inversion that uses a wavefield in the Laplace domain and is thus robust and less sensitive to an initial model. The waveform inversion in the Laplace domain is equivalent to a zero-frequency component of a damped wavefield. In addition, an L₂-norm of logarithmic wavefields in the Laplace domain behaves as if it has no local minimum points in low and high Laplace damping integers.

According to an aspect of the present invention, a method applicable to waveform inversion using a logarithmic wavefield in the Laplace domain is provided. However, the present invention is not limited to the Laplace domain and can be applied to a frequency domain as long as the logarithmic wavefield is used.

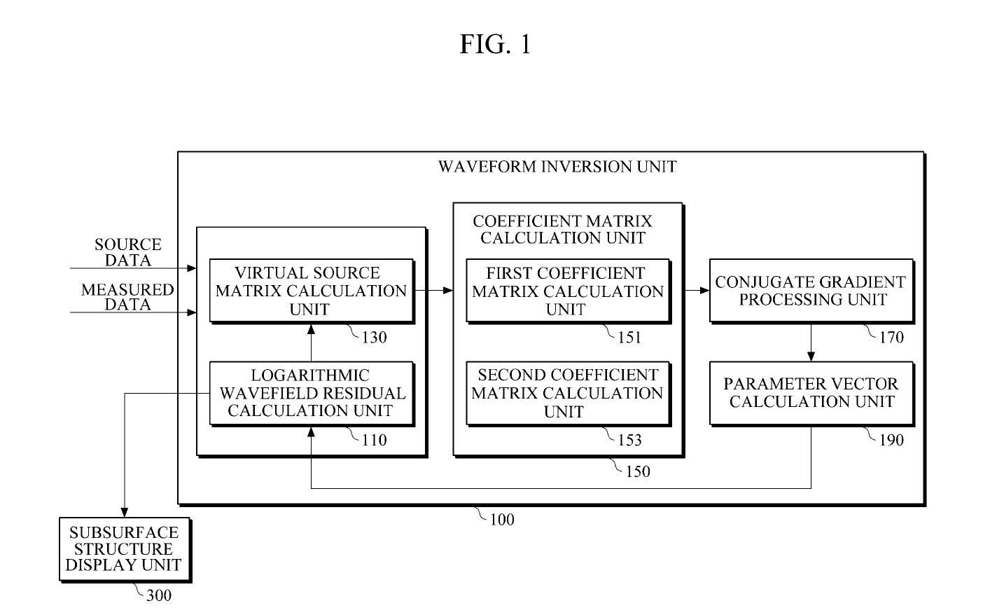

FIG. 1 is a schematic block diagram of a seismic imaging apparatus according to an exemplary embodiment of the present invention. Referring to FIG. 1, the seismic imaging apparatus includes a waveform inversion unit 100 and a subsurface structure display unit 300. The waveform inversion unit 100 obtains an equation by applying a Gauss-Newton method to an objective function consisting of residuals of logarithmic wavefields in the frequency-domain waveform inversion and then obtains a parameter vector, which minimizes the objective function, by solving the equation using a conjugate gradient method. The parameter vector is a solution to the inversion problem and is depictive of the medium through which the wavefield propagates. The subsurface structure display unit 300 generates subsurface structure information using the parameter vector obtained by the waveform inversion unit 100 and displays the generated subsurface structure information.

Specifically, the waveform inversion unit 100 includes a coefficient matrix calculation unit 150 which calculates coefficient matrices of a linear matrix equation obtained by applying the Gauss-Newton method and a conjugate gradient processing unit 170 which iteratively solves is the linear matrix equation having the coefficient matrices calculated by the coefficient matrix calculation unit 150.

For seismic imaging, a vessel on the sea continuously fires an air gun, which is a source, while taking with it a streamer having receivers installed in a matrix form. Then, the receivers measure reflected waves. The streamer may be a hydrophone cable filled with floating oil, and piezoelectric receivers sensing the change in pressure are arranged inside the cable. Cables can be connected in series up to a desired length and usually consists of 24 to 96 channels.

A residual at a j^{th} receiver by an i^{th} source may be expressed as

$$δ {r}_{ij} = ln ( {\tilde{d}}_{ij} ) - ln ( {\tilde{u}}_{ij} ) = ln ( \frac{{\tilde{d}}_{ij}}{{\tilde{u}}_{ij}} ) . \qquad ( 5 )$$

Accordingly, an objective function can be defined by

$$E = {\sum }_{i = 1}^{{n}_{s}} {\sum }_{j = i}^{{n}_{r}} {( δ {r}_{ij} )}^{2} . \qquad ( 6 )$$

Next, the Gauss-Newton method is applied to the objective function, thereby obtaining a perturbation vector Δp that minimizes Equation 6. As a result, a matrix equation for waveform inversion using a logarithmic wavefield is induced as follows through the same process as the process represented by Equations 1 through 3.

$${{[ \begin{matrix}\frac{1}{{u}_{1}} \frac{\partial {u}_{1}}{\partial {p}_{1}} & \frac{1}{{u}_{1}} \frac{\partial {u}_{1}}{\partial {p}_{2}} & … & \frac{1}{{u}_{1}} \frac{\partial {u}_{1}}{\partial {p}_{m}} \\ \frac{1}{{u}_{2}} \frac{\partial {u}_{2}}{\partial {p}_{1}} & \frac{1}{{u}_{2}} \frac{\partial {u}_{2}}{\partial {p}_{2}} & … & \frac{1}{{u}_{2}} \frac{\partial {u}_{2}}{\partial {p}_{m}} \\ ⋮ & ⋮ & ⋱ & ⋮ \\ \frac{1}{{u}_{r}} \frac{\partial {u}_{r}}{\partial {p}_{1}} & \frac{1}{{u}_{r}} \frac{\partial {u}_{r}}{\partial {p}_{2}} & … & \frac{1}{{u}_{r}} \frac{\partial {u}_{r}}{\partial {p}_{m}}\end{matrix} ]}^{T} [ \begin{matrix}\frac{1}{{u}_{1}} \frac{\partial {u}_{1}}{\partial {p}_{1}} & \frac{1}{{u}_{1}} \frac{\partial {u}_{1}}{\partial {p}_{2}} & … & \frac{1}{{u}_{1}} \frac{\partial {u}_{1}}{\partial {p}_{m}} \\ \frac{1}{{u}_{2}} \frac{\partial {u}_{2}}{\partial {p}_{1}} & \frac{1}{{u}_{2}} \frac{\partial {u}_{2}}{\partial {p}_{2}} & … & \frac{1}{{u}_{2}} \frac{\partial {u}_{2}}{\partial {p}_{m}} \\ ⋮ & ⋮ & ⋱ & ⋮ \\ \frac{1}{{u}_{r}} \frac{\partial {u}_{r}}{\partial {p}_{1}} & \frac{1}{{u}_{r}} \frac{\partial {u}_{r}}{\partial {p}_{2}} & … & \frac{1}{{u}_{r}} \frac{\partial {u}_{r}}{\partial {p}_{m}}\end{matrix} ]}^{*} [ \begin{matrix}Δ {p}_{1} \\ Δ {p}_{2} \\ ⋮ \\ Δ {p}_{m}\end{matrix} ] = {{[ \begin{matrix}\frac{1}{{u}_{1}} \frac{\partial {u}_{1}}{\partial {p}_{1}} & \frac{1}{{u}_{1}} \frac{\partial {u}_{1}}{\partial {p}_{2}} & … & \frac{1}{{u}_{1}} \frac{\partial {u}_{1}}{\partial {p}_{m}} \\ \frac{1}{{u}_{2}} \frac{\partial {u}_{2}}{\partial {p}_{1}} & \frac{1}{{u}_{2}} \frac{\partial {u}_{2}}{\partial {p}_{2}} & … & \frac{1}{{u}_{2}} \frac{\partial {u}_{2}}{\partial {p}_{m}} \\ ⋮ & ⋮ & ⋱ & ⋮ \\ \frac{1}{{u}_{r}} \frac{\partial {u}_{r}}{\partial {p}_{1}} & \frac{1}{{u}_{r}} \frac{\partial {u}_{r}}{\partial {p}_{2}} & … & \frac{1}{{u}_{r}} \frac{\partial {u}_{r}}{\partial {p}_{m}}\end{matrix} ]}^{T} [ \begin{matrix}ln \frac{{d}_{1}}{{u}_{1}} \\ ln \frac{{d}_{2}}{{u}_{2}} \\ ⋮ \\ ln \frac{{d}_{r}}{{u}_{r}}\end{matrix} ]}^{*} , \qquad ( 7 )$$

where u is a modeled wavefield, d is an observed wavefield, and Δp is a perturbation of a model parameter. In addition, a subscript r is the number of receivers, and a subscript m is the number of parameters.

Equation 7 includes the multiplication of two m×r matrices which requires a tremendous amount of computation. However, this multiplication is an overburden even with is current high-performance super-computer. A simple method of performing matrix multiplication is available for a general objective function defined by Equation 3. However, no method of performing matrix multiplication is available for a logarithmic objective function defined by Equation 7.

According to an aspect, a method of solving Equation 7 relatively easily by using a method similar in its form to an existing method is suggested. According to the aspect, Equation 7 is rearranged into a linear matrix equation. That is, a Jacobian matrix of Equation 7 may be decomposed into

$${{{[ \begin{matrix}\frac{\partial {u}_{1}}{\partial {p}_{1}} & \frac{\partial {u}_{1}}{\partial {p}_{2}} & … & \frac{\partial {u}_{1}}{\partial {p}_{m}} \\ \frac{\partial {u}_{2}}{\partial {p}_{1}} & \frac{\partial {u}_{2}}{\partial {p}_{2}} & … & \frac{\partial {u}_{2}}{\partial {p}_{m}} \\ ⋮ & ⋮ & ⋱ & ⋮ \\ \frac{\partial {u}_{r}}{\partial {p}_{1}} & \frac{\partial {u}_{r}}{\partial {p}_{2}} & … & \frac{\partial {u}_{r}}{\partial {p}_{m}}\end{matrix} ]}^{T} [ \begin{matrix}\frac{1}{{u}_{1}} & 0 & … & 0 \\ 0 & \frac{1}{{u}_{2}} & … & 0 \\ ⋮ & ⋮ & ⋱ & ⋮ \\ 0 & 0 & … & \frac{1}{{u}_{r}}\end{matrix} ]}^{T} [ \begin{matrix}\frac{1}{{u}_{1}} & 0 & … & 0 \\ 0 & \frac{1}{{u}_{2}} & … & 0 \\ ⋮ & ⋮ & ⋱ & ⋮ \\ 0 & 0 & … & \frac{1}{{u}_{r}}\end{matrix} ]}^{*} {[ \begin{matrix}\frac{\partial {u}_{1}}{\partial {p}_{1}} & \frac{\partial {u}_{1}}{\partial {p}_{2}} & … & \frac{\partial {u}_{1}}{\partial {p}_{m}} \\ \frac{\partial {u}_{2}}{\partial {p}_{1}} & \frac{\partial {u}_{2}}{\partial {p}_{2}} & … & \frac{\partial {u}_{2}}{\partial {p}_{m}} \\ ⋮ & ⋮ & ⋱ & ⋮ \\ \frac{\partial {u}_{r}}{\partial {p}_{1}} & \frac{\partial {u}_{r}}{\partial {p}_{2}} & … & \frac{\partial {u}_{r}}{\partial {p}_{m}}\end{matrix} ]}^{*} [ \begin{matrix}Δ {p}_{1} \\ Δ {p}_{2} \\ ⋮ \\ Δ {p}_{m}\end{matrix} ] = {{{[ \begin{matrix}\frac{\partial {u}_{1}}{\partial {p}_{1}} & \frac{\partial {u}_{1}}{\partial {p}_{2}} & … & \frac{\partial {u}_{1}}{\partial {p}_{m}} \\ \frac{\partial {u}_{2}}{\partial {p}_{1}} & \frac{\partial {u}_{2}}{\partial {p}_{2}} & … & \frac{\partial {u}_{2}}{\partial {p}_{m}} \\ ⋮ & ⋮ & ⋱ & ⋮ \\ \frac{\partial {u}_{r}}{\partial {p}_{1}} & \frac{\partial {u}_{r}}{\partial {p}_{2}} & … & \frac{\partial {u}_{r}}{\partial {p}_{m}}\end{matrix} ]}^{T} [ \begin{matrix}\frac{1}{{u}_{1}} & 0 & … & 0 \\ 0 & \frac{1}{{u}_{2}} & … & 0 \\ ⋮ & ⋮ & ⋱ & ⋮ \\ 0 & 0 & … & \frac{1}{{u}_{r}}\end{matrix} ]}^{T} [ \begin{matrix}ln \frac{{d}_{1}}{{u}_{1}} \\ ln \frac{{d}_{2}}{{u}_{2}} \\ ⋮ \\ ln \frac{{d}_{r}}{{u}_{r}}\end{matrix} ]}^{*} . \qquad ( 8 )$$

Equation 8 may be rearranged into

$${[ \begin{matrix}\frac{\partial {u}_{1}}{\partial {p}_{1}} & \frac{\partial {u}_{1}}{\partial {p}_{2}} & … & \frac{\partial {u}_{1}}{\partial {p}_{m}} \\ \frac{\partial {u}_{2}}{\partial {p}_{1}} & \frac{\partial {u}_{2}}{\partial {p}_{2}} & … & \frac{\partial {u}_{2}}{\partial {p}_{m}} \\ ⋮ & ⋮ & ⋱ & ⋮ \\ \frac{\partial {u}_{r}}{\partial {p}_{1}} & \frac{\partial {u}_{r}}{\partial {p}_{2}} & … & \frac{\partial {u}_{r}}{\partial {p}_{m}}\end{matrix} ]}^{T} [ \begin{matrix}\frac{1}{{u}_{1} {u}_{1}^{*}} & 0 & … & 0 \\ 0 & \frac{1}{{u}_{2} {u}_{2}^{*}} & … & 0 \\ ⋮ & ⋮ & ⋱ & ⋮ \\ 0 & 0 & … & \frac{1}{{u}_{r} {u}_{r}^{*}}\end{matrix} ] {[ \begin{matrix}\frac{\partial {u}_{1}}{\partial {p}_{1}} & \frac{\partial {u}_{1}}{\partial {p}_{2}} & … & \frac{\partial {u}_{1}}{\partial {p}_{m}} \\ \frac{\partial {u}_{2}}{\partial {p}_{1}} & \frac{\partial {u}_{2}}{\partial {p}_{2}} & … & \frac{\partial {u}_{2}}{\partial {p}_{m}} \\ ⋮ & ⋮ & ⋱ & ⋮ \\ \frac{\partial {u}_{r}}{\partial {p}_{1}} & \frac{\partial {u}_{r}}{\partial {p}_{2}} & … & \frac{\partial {u}_{r}}{\partial {p}_{m}}\end{matrix} ]}^{*} [ \begin{matrix}Δ {p}_{1} \\ Δ {p}_{2} \\ ⋮ \\ Δ {p}_{m}\end{matrix} ] = {[ \begin{matrix}\frac{\partial {u}_{1}}{\partial {p}_{1}} & \frac{\partial {u}_{1}}{\partial {p}_{2}} & … & \frac{\partial {u}_{1}}{\partial {p}_{m}} \\ \frac{\partial {u}_{2}}{\partial {p}_{1}} & \frac{\partial {u}_{2}}{\partial {p}_{2}} & … & \frac{\partial {u}_{2}}{\partial {p}_{m}} \\ ⋮ & ⋮ & ⋱ & ⋮ \\ \frac{\partial {u}_{r}}{\partial {p}_{1}} & \frac{\partial {u}_{r}}{\partial {p}_{2}} & … & \frac{\partial {u}_{r}}{\partial {p}_{m}}\end{matrix} ]}^{T} [ \begin{matrix}\frac{1}{{u}_{1}} {( ln \frac{{d}_{1}}{{u}_{1}} )}^{*} \\ \frac{1}{{u}_{2}} {( ln \frac{{d}_{2}}{{u}_{2}} )}^{*} \\ ⋮ \\ \frac{1}{{u}_{r}} {( ln \frac{{d}_{r}}{{u}_{r}} )}^{*}\end{matrix} ] . \qquad ( 9 )$$

To obtain the Jacobian matrix in Equation 9, wave equation modeling is defined by the following linear algebraic equation.

$$[ {S}_{0} ] [ \begin{matrix}{u}_{1} \\ {u}_{2} \\ ⋮ \\ {u}_{n}\end{matrix} ] = [ f ] , \qquad ( 10 )$$

where S₀ is a complex impedance matrix using an initial velocity model f is a source vector, and a subscript n is the number of grid points of the model. Dividing both sides of Equation 10 by p₁ yields the following equation.

$$[ {S}_{0} ] [ \begin{matrix}\frac{\partial {u}_{1}}{\partial {p}_{1}} \\ \frac{\partial {u}_{2}}{\partial {p}_{1}} \\ ⋮ \\ \frac{\partial {u}_{n}}{\partial {p}_{1}}\end{matrix} ] = - \frac{\partial }{\partial {p}_{1}} [ {S}_{0} ] [ \begin{matrix}{u}_{1} \\ {u}_{2} \\ ⋮ \\ {u}_{n}\end{matrix} ] . \qquad ( 11 )$$

Here, since the right-hand side of Equation 11 can be assumed as a kind of source vector, it is defined as a virtual source vector v₁. If the above process is iterated for parameters p₂ through pₘ, the Jacobian matrix can be obtained as follows.

$$[ \begin{matrix}\frac{\partial {u}_{1}}{\partial {p}_{1}} & \frac{\partial {u}_{1}}{\partial {p}_{2}} & … & \frac{\partial {u}_{1}}{\partial {p}_{m}} \\ \frac{\partial {u}_{2}}{\partial {p}_{1}} & \frac{\partial {u}_{2}}{\partial {p}_{2}} & … & \frac{\partial {u}_{2}}{\partial {p}_{m}} \\ ⋮ & ⋮ & ⋱ & ⋮ \\ \frac{\partial {u}_{n}}{\partial {p}_{1}} & \frac{\partial {u}_{n}}{\partial {p}_{2}} & … & \frac{\partial {u}_{n}}{\partial {p}_{m}}\end{matrix} ] = {[ {S}_{0} ]}^{- 1} [ \begin{matrix}{v}_{1} & {v}_{2} & {v}_{m}\end{matrix} ] . \qquad ( 12 )$$

By using Equation 12, the Jacobian matrix of Equation 9 can be calculated as follows.

J=AS₀⁻¹V (13).

Here, a matrix A is expressed as an r×m matrix for limiting elements in receiver points.

$$A = [ \begin{matrix}1 & 0 & … & 0 & 0 & … & 0 \\ 0 & 1 & … & 0 & 0 & … & 0 \\ ⋮ & ⋮ & ⋱ & ⋮ & ⋮ & ⋱ & ⋮ \\ 0 & 0 & … & 1 & 0 & … & 0\end{matrix} ] . \qquad ( 14 )$$

In addition, a matrix V consists of virtual source vectors defined above.

V=[v₁v₂ . . . vₘ] (15).

That is, if vᵢ is a virtual source vector,

$${v}_{i} = - \frac{\partial }{\partial {p}_{i}} [ {S}_{0} ] [ \begin{matrix}{u}_{1} \\ {u}_{2} \\ ⋮ \\ {u}_{n }\end{matrix} ] .$$

Substituting Equation 13 into Equation 9 yields

$$\begin{matrix}{( {AS}_{0}^{- 1} V )}^{T} {U ( {AS}_{0}^{- 1} V )}^{*} Δ p = {( {AS}_{0}^{- 1} V )}^{T} {e}_{r} . & ( 16 ) \\ Here , U = [ \begin{matrix}\frac{1}{{u}_{1} {u}_{1}^{*}} & 0 & … & 0 \\ 0 & \frac{1}{{u}_{2} {u}_{2}^{*}} & … & 0 \\ ⋮ & ⋮ & ⋱ & ⋮ \\ 0 & 0 & … & \frac{1}{{u}_{r} {u}_{r }^{*}}\end{matrix} ] , and & ( 17 ) \\ {e}_{r} = [ \begin{matrix}\frac{1}{{u}_{1 }} {( ln \frac{{d}_{1}}{{u}_{1}} )}^{*} \\ \frac{1}{{u}_{2}} {( ln \frac{{d}_{2}}{{u}_{2}} )}^{* } \\ ⋮ \\ \frac{1}{{u}_{r}} {( ln \frac{{d}_{r}}{{u}_{r}} )}^{*}\end{matrix} ] . & ( 18 )\end{matrix}$$

Since the matrix S₀ is symmetric, Equation (16) can be expressed as

V^{T}S₀⁻¹A^{T}UA(S₀⁻¹V)*Δp=V^{T}S₀⁻¹A^{T}eᵣ (19).

Equation (19) can be rearranged into

V^{T}S₀⁻¹Uₐ(S₀⁻¹V)*Δp=V^{T}S₀⁻¹eₐ (20).

Here, a matrix Uₐ is an n×n matrix and is expressed as

$${U}_{a} = [ \begin{matrix}U & 0 \\ 0 & 0\end{matrix} ] . \qquad ( 21 )$$

In addition, a vector eₐ, which is a transformed residual vector, has n elements and is expressed as

$${e}_{a} = [ \begin{matrix}{e}_{r} \\ 0\end{matrix} ] . \qquad ( 22 )$$

Therefore, Equation 20 can be simplified into

HΔp=g, (23)

where

H=V^{T}S⁻¹₀Uₐ(S⁻¹₀V)*, and g=V^{T}S⁻¹₀eₐ. (23)

Finally, a perturbation Δp can be obtained by solving this simple linear matrix equation.

A virtual source matrix calculation unit 130 illustrated in FIG. 1 receives source data and sequentially calculates

$${v}_{i} = - \frac{\partial }{\partial {p}_{i}} [ {S}_{0} ] [ \begin{matrix}{u}_{1} \\ {u}_{2} \\ ⋮ \\ {u}_{n}\end{matrix} ]$$

Where vᵢ is a virtual source vector, thereby producing virtual source vectors included in Equation 15. In addition, a logarithmic wavefield residual calculation unit 110 receives measured data, calculates a logarithmic wavefield residual, solves Equation 18 using the calculated logarithmic wavefield residual, and then calculates the transformed residual vector eₐ.

That is, a logarithmic wavefield residual

$$ln \frac{{d}_{i}}{{u}_{i}}$$

is calculated using measured data, and

$${e}_{r} = [ \begin{matrix}\frac{1}{{u}_{1}} {( ln \frac{{d}_{1}}{{u}_{1}} )}^{*} \\ \frac{1}{{u}_{2 }} {( ln \frac{{d}_{2}}{{u}_{2}} )}^{*} \\ ⋮ \\ \frac{1}{{u}_{r}} {( ln \frac{{d}_{r}}{{u}_{r}} )}^{*}\end{matrix} ]$$

is calculated using the calculated logarithmic wavefield residual. In addition, is the transformed residual vector

$${e}_{a} = [ \begin{matrix}{e}_{r} \\ 0\end{matrix} ]$$

is constructed using eᵣ by augmenting zeroes.

The coefficient matrix calculation unit 150 calculates coefficient matrices H and g by using Equation 23. According to an aspect, the coefficient matrix calculation unit 150 includes a first coefficient matrix calculation unit 151 which calculates the coefficient matrix H by sequentially back-propagating a first virtual source vector for first modeling vectors. That is, in Equation 23, the coefficient matrix H includes the multiplication of a virtual source matrix V and an inverse matrix S⁻¹₀ of a wavefield modeling complex impedance matrix using an initial velocity model. This multiplication is calculated by a modeling utilizing the virtual source matrix V. That is, this multiplication can be calculated by back-propagating the linearly combined virtual source vector VΔp, firstly by S⁻¹₀. Next, (S⁻¹₀V)*Δp is calculated by obtaining a complex conjugate of the propagated wavefield. Then, the calculated (S⁻¹₀V)*Δp is multiplied by the simple matrix Uₐ, and the multiplication result is back-propagated once again by S⁻¹₀ and is multiplied by a transpose matrix of the virtual source matrix V. That is, since a previous result is backward propagated in the above process, the multiplication of large matrices can be avoided, thus reducing the amount of computation.

Similarly, the coefficient matrix calculation unit 150 includes a second coefficient matrix calculation unit 153 which calculates the coefficient matrix g by sequentially back-propagating a second virtual source vector for second modeling vectors. That is, the transformed residual vector eₐ is assumed as another virtual source and is then propagated for S⁻¹₀ which is an inverse matrix of a wavefield modeling complex impedance matrix using an initial velocity model. Then, the coefficient matrix g is calculated by multiplying the calculated back-propagated residual vector S⁻¹₀eₐ by a transpose matrix of the virtual source matrix V.

After the coefficient matrix calculation unit 150 calculates the coefficient matrices of the linear matrix equation defined by Equation 23, the conjugate gradient processing unit 170 solves the linear matrix equation by using the conjugate gradient method, thereby obtaining the perturbation Δp. An example algorithm for this process is shown below.

| HΔp = g | | |
|---|---|---|
| β₀ = 0, d₋₁ = 0, r₀ = g − HΔp₀ | | |
| $do while ( i < {i}_{max} \& \frac{‖ {r}_{i} ‖}{‖ {r}_{0} ‖} > ɛ )$ | | |
| | If (i > 0) then | |
| | | ${β}_{i} = \frac{{r}_{i}^{T} {r}_{i}}{{r}_{i - 1}^{T} {r}_{i - 1}}$ |

end if
dᵢ = rᵢ + βᵢdᵢ₋₁
${α}_{i} = \frac{{r}_{i}^{T} {r}_{i}}{{d}_{i}^{T} {Hd}_{i}}$
Δpᵢ₊₁ = Δpᵢ + αᵢdᵢ
rᵢ₊₁ = rᵢ − αᵢHdᵢ
i = i + 1

end do

In the process of iteratively solving the linear matrix equation, the conjugate gradient processing unit 170 performs matrix multiplication using a back-propagation method. That is, to calculate dᵢ^{T}Hdᵢ which is matrix multiplication iteratively performed in the iterative loop, a dᵢ vector (which is a conjugate gradient direction in this case) is propagated by the Hessian matrix H, and the multiplication result is multiplied by a transpose of the dᵢ vector. Accordingly, the direct multiplication of large matrices can be avoided, thus reducing the amount of computation.

The subsurface structure display unit 300 further includes a parameter vector calculation unit 190 which obtains a parameter vector from the perturbation Δp obtained by the conjugate gradient processing unit 170. The parameter vector calculation unit 190 obtains the parameter vector from the perturbation Δp by using the following equation.

P^{(k+1)}=P^{(k)}+ΔP

After the parameter vector calculation unit 190 obtains the parameter vector, the logarithmic wavefield residual calculation unit 110 calculates a logarithmic wavefield residual and determines whether the calculated logarithmic wavefield residual is equal to or less than a predetermined value. When determining that the calculated logarithmic wavefield residual is equal to or less than the predetermined value, the logarithmic wavefield residual calculation unit 110 determines that the parameter vector is close to an actual model and outputs the calculated parameter vector to the subsurface structure display unit 300. When determining that the calculated logarithmic waveform residual exceeds the predetermined value, the logarithmic wavefield residual calculation unit 110 iterates the process of calculating the perturbation Δp and updating the parameter vector.

A method that applies the Gauss-Newton method to logarithmic waveform inversion is provided. Since a numerical solution that minimizes a logarithmic objective function is provided, waveform inversion with faster convergence is possible. That is, the amount or speed of computation can be improved.

While this invention has been particularly shown and described with reference to equations and drawings, it encompasses obvious modified examples that can be easily conceived by those skilled in the art. The appended claims are intended to encompass these obvious modified examples.

1. A seismic imaging apparatus comprising:
a waveform inversion unit obtaining an equation by applying a Gauss-Newton method to an objective function consisting of residuals of logarithmic wavefields in the frequency-domain waveform inversion and then obtaining a parameter vector, which minimizes the objective function, by solving the equation using a conjugate gradient method; and
a subsurface structure display unit generating subsurface structure information using the parameter vector obtained by the waveform inversion unit and displaying the generated subsurface structure information.

2. The apparatus of claim 1, wherein the waveform inversion unit comprises:
a coefficient matrix calculation unit calculating coefficient matrices of a linear matrix equation obtained by applying the Gauss-Newton method; and
a conjugate gradient processing unit iteratively solving the linear matrix equation, which has the coefficient matrices calculated by the coefficient matrix calculation unit, by using the conjugate gradient method.

3. The apparatus of claim 2, wherein the conjugate gradient processing unit performs matrix multiplication using a back-propagation method when iteratively solving the linear matrix equation

4. The apparatus of claim 2, wherein the coefficient matrices calculated by the coefficient matrix calculation unit are defined by H=V^{T}S⁻¹₀Uₐ(S⁻¹₀V)* and g=V^{T}S⁻¹₀eₐ, where S₀ is a coefficient matrix of a linear wave equation, V is a matrix assumed as a virtual source in an equation obtained by differentiating the linear wave equation with respect to a parameter vector, and U is a matrix, and eₐ is a transformed residual vector.

5. The apparatus of claim 4, wherein the coefficient matrix calculation unit comprises a first coefficient matrix calculation unit which calculates the coefficient matrix H by sequentially back-propagating a first virtual source vector for first modeling vectors.

6. The apparatus of claim 4, wherein the coefficient matrix calculation unit comprises a second coefficient matrix calculation unit which calculates the coefficient matrix g by sequentially back-propagating a second virtual source vector for second modeling vectors.

7. The apparatus of claim 4, wherein the matrix assumed as the virtual source is defined by V=[v₁ v₂ . . . vₘ]
$${v}_{i} = - \frac{\partial }{\partial {p}_{i}} [ {S}_{0} ] [ \begin{matrix}{u}_{1} \\ {u}_{2} \\ ⋮ \\ {u}_{n }\end{matrix} ] ,$$
where uᵢ is a velocity vector.

8. The apparatus of claim 4, wherein the transformed residual vector is given by
$${e}_{a} = [ \begin{matrix}{e}_{r} \\ 0\end{matrix} ] when {e}_{r} = [ \begin{matrix}\frac{1}{{u}_{1}} {( ln \frac{{d}_{1}}{{u}_{1}} )}^{*} \\ \frac{1}{{u}_{2}} {( ln \frac{{d}_{2}}{{u}_{2}} )}^{*} \\ ⋮ \\ \frac{1}{{u}_{r}} {( ln \frac{{d}_{r}}{{u}_{r}} )}^{*}\end{matrix} ] .$$

9. A seismic imaging method comprising:
obtaining an equation by applying a Gauss-Newton method to an objective function consisting of residuals of logarithmic wavefields in frequency-domain waveform inversion and then obtaining a parameter vector, which minimizes the objective function, by solving the equation using a conjugate gradient method; and
generating subsurface structure information using the obtained parameter vector and displaying the generated subsurface structure information.

10. The method of claim 9, wherein the obtaining of the equation and the obtaining of the parameter vector comprises:
calculating coefficient matrices of a linear matrix equation obtained by applying the Gauss-Newton method; and
iteratively solving the linear matrix equation, which has the calculated coefficient matrices, by using the conjugate gradient method.

11. The method of claim 10, wherein in the iterative solving of the linear matrix equation, matrix multiplication is performed using a back-propagation method in the process of iteratively solving the linear matrix equation

12. The method of claim 10, wherein the calculated coefficient matrices are defined by H=V^{T}S⁻¹₀Uₐ(S⁻¹₀V)* and g=V^{T}S⁻¹₀eₐ, where S₀ is a coefficient matrix of a linear wave equation, V is a matrix assumed as a virtual source in an equation obtained by differentiating the linear wave equation with respect to a parameter vector, and U is a matrix, and eₐ is a transformed residual vector.

13. The method of claim 12, wherein the calculating of the coefficient matrices comprises calculating the coefficient matrix H by sequentially back-propagating a first virtual source vector for first modeling vectors.

14. The method of claim 12, wherein the calculating of the coefficient matrices comprises calculating the coefficient matrix g by sequentially back-propagating a second virtual source vector for second modeling vectors.

15. The method of claim 12, wherein the matrix assumed as the virtual source is defined by V=[v₁ v₂ . . . vₘ]
$${v}_{i} = - \frac{\partial }{\partial {p}_{i}} [ {S}_{0} ] [ \begin{matrix}{u}_{1} \\ {u}_{2} \\ ⋮ \\ {u}_{n}\end{matrix} ] ,$$
where vᵢ is a virtual source vector.

16. The method of claim 12, wherein the transformed residual vector is given by
$${e}_{a} = [ \begin{matrix}{e}_{r} \\ 0\end{matrix} ] when {e}_{r} = [ \begin{matrix}\frac{1}{{u}_{1}} {( ln \frac{{d}_{1}}{{u}_{1}} )}^{*} \\ \frac{1}{{u}_{2}} {( ln \frac{{d}_{2}}{{u}_{2}} )}^{*} \\ ⋮ \\ \frac{1}{{u}_{r}} {( ln \frac{{d}_{r}}{{u}_{r}} )}^{*}\end{matrix} ] .$$

17. A computer-readable recording medium on which a program for executing the method of claim 9 is recorded.
